(19) United States
(12) Patent Application Publication
(10) Pub. No.: US 2005/0061833 A1
(43) Pub. Date: Mar. 24, 2005

(54) Manual pump with integrated components

(76) Inventors: Eric Michael Boettner, Charleston, TN (US); Frank Timothy Hoffman, Englewood, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 10/923,210

(22) Filed: Aug. 20, 2004

Related U.S. Application Data
(60) Provisional application No. 60/498,679, filed on Aug. 28, 2003.

(51) Int. Cl. B67D 5/42

(52) U.S. Cl. 222/207; 222/321.7

(57) ABSTRACT

A manual pump is provided having a corrugated section defining a spring walled short chamber and enabling the pump to be manufactured with only three integrally formed pieces utilizing blow or vacuum molding processes, and optionally one or two check valve balls.

This application claims the benefit of the Aug. 21, 2003 filing date of U.S. Ser. No. 60/498,679.

### FIELD OF THE INVENTION

This invention relates to manual dispensing pumps and particularly those adapted to dispense the contents of bottles or other containers.

### BACKGROUND OF THE INVENTION

The manual dispensing pump is a common device in many consumable product packages. A popular application for manual pumps is personal hygiene products, such as soft soap and skin moisturizer. In a typical pump, the push-member-distributor is pressed down with the hand, and the liquid pressed out of the piston cylinder is dispensed into the hand. Releasing the push-member-distributor allows the return spring action to lift the piston to the extended position, thereby refilling the cylinder with fresh liquid. Generally, such pumps have common features, which are dip tube, check valves seats, piston, cylinder, cap seal, return spring, cap, push-member-distributor, cap spindle, support ring, and check valve balls.

The manufacture and assembly of this many parts necessarily involves cost, and as dispensing pumps are mass produced for use with consumer products, even small cost savings on each device may become substantial. In the consumer product field, it is also very desirable to provide tamper evident features during mass manufacture to minimize costs.

### SUMMARY OF THE INVENTION

This invention provides lower costs of manufacture by reducing the number of parts required and by producing the parts in a plastic forming process not previously applied to manual pump production.

This invention, in the preferred arrangement, combines the dip tube, check valve seal, and support ring in a lower part. The threaded cap, cylinder, piston, return spring and cap spindle are combined in an upper part, however, a corrugated shot reservoir provides the function of the prior art cylinder, piston and return spring. An alternative arrangement combines the dip tube, support ring, return spring, and cap spindle in the lower part, with a threaded cap and cap-cover combined in the upper part. The cost of manufacturing the pump assembly is reduced, since the number of parts has been reduced.

In most current pumps, all plastic parts other than the dip tube are injection molded. Dip tubes are commonly extruded. Compared to the vacuum corrugation plastic thermo-forming process, injection molding is slow, and therefore more expensive. This invention is compatible with the blow molding and vacuum corrugation process. Blow molding is a well known art and the vacuum corrugation process is generally described in Dickhut, et al., U.S. Pat. No. 6,193,496 and Berns, et al., U.S. Pat. No. 5,494,430.

A new tamper evident feature is easily incorporated in this invention. A fin added to the push-member-distributor can be sealed with the tamper evident-structural stiffener at assembly. The end user breaks this seal and rotates the dispensing nozzle a quarter turn to unseal the product.

Another variation of this invention is to integrate a reed valve into either of the two valve seats to eliminate two additional parts, the check valve balls.

A second variation eliminates one of the check valve balls by adding an attached flap to the dip tube-annular support ring or the cap-bellows-return spring member. This flap acts as a reed valve, eliminating the need for one of the movable check valve balls.

### DETAILED DESCRIPTION OF THE DRAWINGS

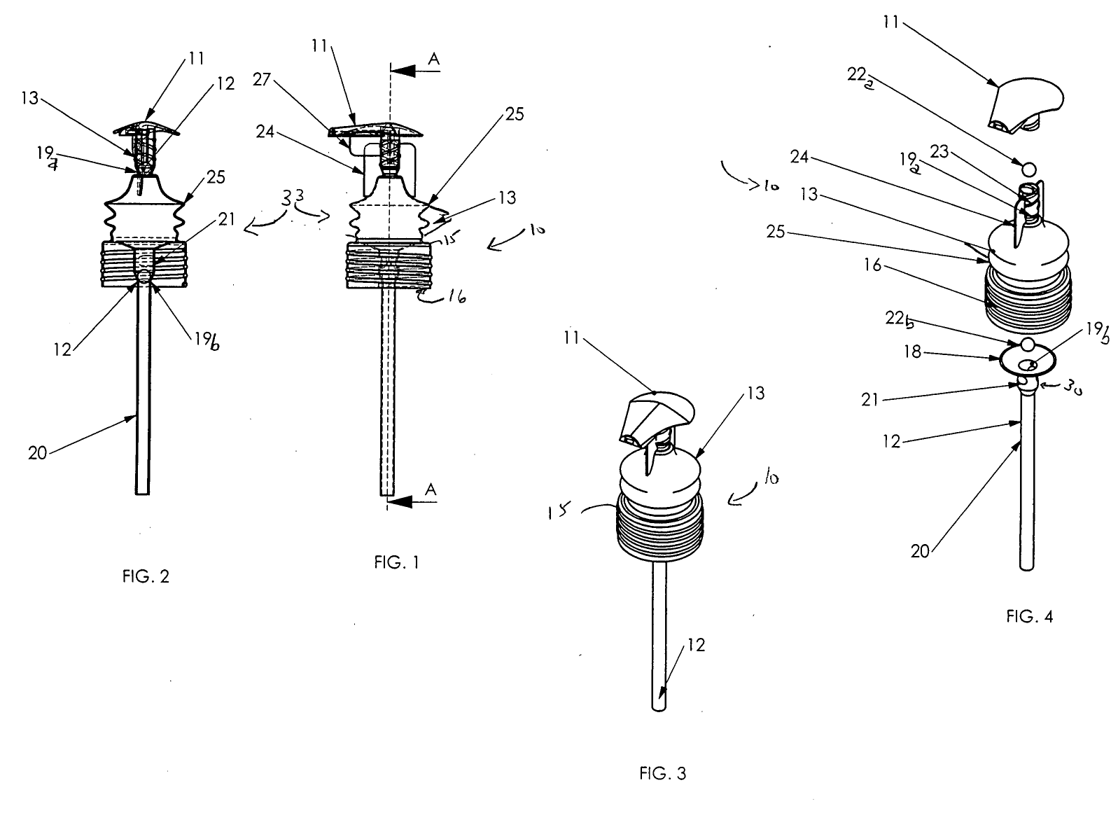

FIG. 1 is a right elevation view of an embodiment of the invention.

FIG. 2 is a section view of the embodiment of FIG. 1 taken along line A-A.

FIG. 3 is a perspective view of the embodiment of FIG. 1.

FIG. 4 is an exploded perspective view of the components of the embodiment of FIG. 1.

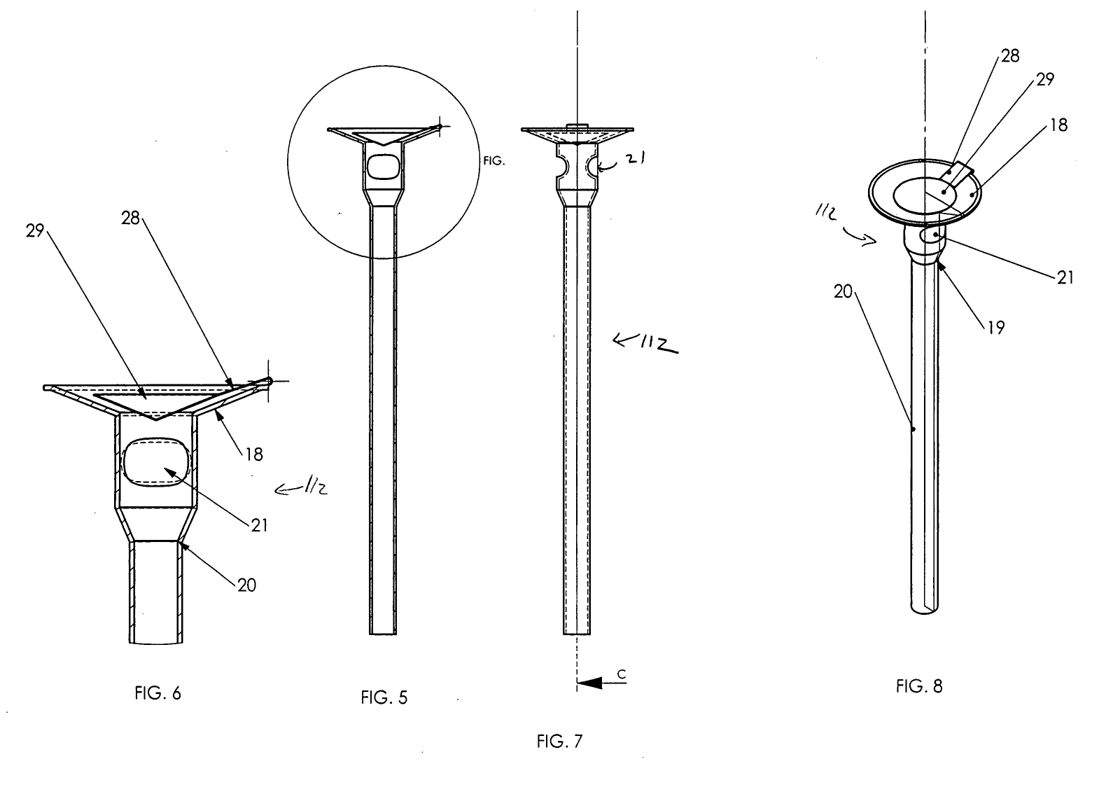

FIG. 5 is a section view of an alternate configuration for the lower check valve of the invention.

FIG. 6 is an expanded view of the section view of FIG. 5.

FIG. 7 is a side elevation view of the embodiment of FIG. 5.

FIG. 8 is a perspective view of the embodiment of FIG. 5.

FIG. 9 shows a side elevation of an alternate pump assembly of the invention with tamper-evident structural stiffener.

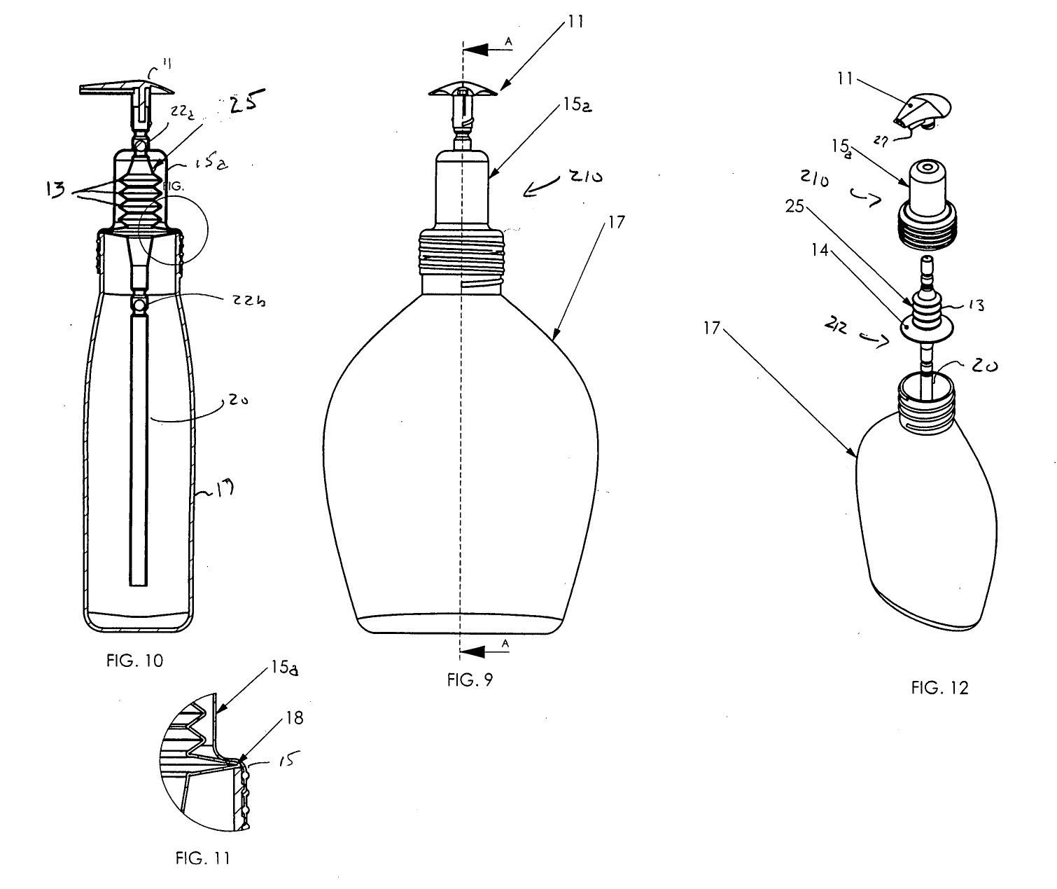

FIG. 10 is a section view of the embodiment of FIG. 9.

FIG. 11 is a detailed section view of part of the embodiment of FIG. 10, showing the seal formed by the cap-cover and annular support ring.

FIG. 12 is an exploded perspective view of the embodiment of FIG. 9.

### DETAILED DESCRIPTION OF THE INVENTION

Turning first to FIG. 4, a lower segment 12 may be referred to as dip tube-annular support ring member and is generally constituted of thermo-formed plastic. The annular support ring 18 generally positions the dip tube 20 in the center of a container opening. The container 17, as shown in FIG. 9, holds a fluid to be pumped. The dip tube 20 is a straw-like member, or a tube with lumen therein which connects to the base 30 of the annular support ring 18. An opening in the center of annular support ring 18 connects to an opening in the base 30 and serves as a lower check valve seat 19b. The base 30 has retaining detents 21 that prevent lower check ball 22b from passing upward through the opening in the annular support spring 18. In use, the dip tube 20 draws fluid from the container and directs the fluid into the upper segment 33, here defined as the cap-bellows-return spring component. In a preferred structure, the outer circumference of the annular support ring 18 fits on the top of the container opening and the cap 15 with annular thread 16 is screwed onto mating annular threads at the container top to thereby clamp the annular support ring 18 between the cap 15 and the container top.

The upper segment 23 generally has a cap 15 with internal annular thread 16 and a bellows return spring portion 13 that in its expanded state defines an internal shot reservoir 25. However, when the bellows return spring 13 is collapsed so that its corrugated external walls are folded upon one another, it correspondingly reduces the height of the shot reservoir 25 and expels the contents of the shot reservoir 25. At the upper end of shot reservoir 25 is a short tube with annular thread 23 and in a preferred embodiment, tamper evident-structural stiffener 24. An upper check ball 22a is received in the top of this tube and rests on an upper valve seat 19a. A push member distributor 11 having a channel therein is initially mounted upon the short tube and turned upon annular thread 23. A tamper evident fin 27 on push member distributor 11 may be heat staked, sonically welded or otherwise joined to tamper evident stiffener 24.

A container utilizing this manual pump would be shipped with the pump 10 in the configuration of FIGS. 1, 2 mounted to the container 17. When used for the first time, push member distributor 11 is rotated counterclockwise. This rotation breaks the seal between tamper evident stiffener 24 and tamper evident fin 27. As the push member distributor 11 is rotated one quarter turn, the push member distributor 11 is lifted upwards upon the annular threads 23 of the short tube and away from upper check valve ball 22a. To complete the setup product, the push member distributor 11 is pressed downward to prime the shot reservoir 25 with liquid from the container 17. The downward push causes the shot reservoir 25 to collapse and the air to be expelled upward and outward through the channel in the push member distributor 11. After the air has been expelled, upper check ball valve 22a returns to its rest on upper valve seat 19a, and the spring pressure of corrugated bellows return spring 13 causes the shot reservoir to again expand. The expansion of shot reservoir 25 creates a vacuum that is filled by drawing fluid up dip tube 20 into shot reservoir. Lower check valve ball 22b then prevents liquid from returning to the container by sealing lower check valve seat 19b. Retaining detents 21 prevent the lower check valve ball 22 from flowing upward into the shot reservoir with the liquid. So long as the pump remains primed, every subsequent press of the push member distributor 11 will deliver fluid from the container to the end user.

When the push member distributor 11 is pressed by the user, the bellows return spring 13 reduces the volume of shot reservoir 25 increasing pressure. The upper check valve ball 22a and lower check valve ball 22b are pushed away from the shot reservoir 25 by this pressure, forcing the lower check valve ball 22b against the lower check valve seat 19b, while lifting the upper check valve ball 22a above the upper check valve seat 19a. This permits the liquid to pass through only the upper opening past the upper check valve so that liquid passes around the upper check valve ball 22a which has been pushed upward away from the upper check valve seat 19a but without closing the channel passing through push member distributor 11 through which the liquid is dispensed. When the push member distributor 11 is released by the user, the spring feature of the corrugated bellows return spring 13 lifts the push member distributor 11 and correspondingly increases the volume of shot reservoir 25. The upper check valve ball 22a and lower check valve ball 22b are correspondingly drawn toward the shot reservoir 25. This seals the upper check valve ball 22a against the upper check valve seat 19a while lifting the lower check valve ball 22b from the lower check valve seat 19b and thereby allowing fluid from the container to flow upward through the dip tube 20 into the shot reservoir 25.

As shown in FIGS. 1 and 2 in its initial shipping position, the pump 10 has the push member distributor 11 collapsed upon the upper segment 13 which holds upper check valve ball 22a against upper check valve seat 19a and thereby effectively blocking fluid flow during shipment. Push member distributor 11 presses against the check valve ball 22a until the user has rotated the push member distributor 11 a quarter turn so that the rotary action of threads in push member distributor 11 and the annular thread 23 above the shot reservoir moves push member distributor 11 upward and releases the upper check valve ball 22a so that it can move above upper check valve seat 19a and thereby permit liquid to pass through the upper check valve. It will be noted that particularly through the use of a corrugator to form pump components, the lower segment 12 can be integrally formed, the upper segment 33 comprising a cap bellows and tamper evident stiffener being integrally formed, and the push member distributor 11 being integrally formed so that with check valve balls 22a, 22b the entire pump assembly consists of only five separate components.

FIGS. 5 through 8 show an alternative configuration for the lower segment 112 with dip tube 20 and annular support ring 18. In this structure, the lower check valve ball 22b of FIGS. 1-4 has been eliminated by adding a reed valve hinge 28 and reed valve flap 29. The reed valve hinge and flap 28, 29 may be integrally formed when lower member 112 is constructed, as on a corrugator, and then folded into place. The elimination of lower check valve ball 22b from the structure of FIGS. 1-4 reduces further the number of parts required to create pump 10. The detents 21 shown in FIG. 7 are also not required in the absence of lower check valve ball.

FIGS. 9 through 12 show a third alternative configuration for the pump assembly as mounted in container 17. Rather than having the shot reservoir 25 formed as a part of the upper pump segment, instead the bellows return spring 13 and shot reservoir 25 are integrated into the lower segment 212. This segment consists of dip tube 20, a lower check valve ball 22b (shown in FIG. 10), a bellows return spring 13 terminating in a lower wider annular segment 14 that extends to the approximate width of the container opening. As shown in FIG. 11, the outermost portion of this fold 14 comprises the annular support ring 18 that is captured by the cap 15 where it joins the top of the opening of the container 17. The shot reservoir 25 in this instance is preferably concealed within an upper cap cover 15a to better support push member distributor 11 due to the inherently narrower bellows return spring segment 13 in this construction.

The tamper evident-structural stiffener of FIGS. 1-4 may be added to the cap cover 15a if desired, or tamper evident fin 27 may be welded directly to cover 15a if a tamper indicator is desired. When this third embodiment of the pump 210 is in use, air is drawn into the container 17 when the shot reservoir 25 extends from compressed to extended condition. The air may easily flow into the cap cover 15a, but it may be necessary to notch one or both of the annular support ring 18 or top of container opening to provide a flow path into the container 17.

In each instance described above, the number of components of the manual pump is considerably reduced. The use of a corrugated bellows section to provide return spring action for the push member distributor and to refill the shot reservoir 25 effectively eliminates the requirement of separate piston, cylinder and return spring present in most manual pumps.

Although preferred embodiments of the present invention have been disclosed in detail herein, it will be understood that various substitutions and modifications may be made to the disclosed embodiment described herein without departing from the scope and spirit of the present invention as recited in the appended claims.

1. A manual pump assembly, comprising:
a integral lower part having a dip tube, a check valve seat, an annular support ring and a retaining detent;
an integral upper part having a threaded cap, a return spring bellows defining a shot cavity therein, a valve seat, and a threaded tube; and
a push member distributor mounted on the threaded tube.

2. The manual pump assembly of claim 1 wherein the push-member distributor has an integral tamper evident fin, and the upper part has an integral tamper evident stiffener
whereby the said integral tamper evident fin is placed against the tamper evident structural stiffener and tacked to said structural stiffener, thereby creating a tamper-evident seal.

3-6. (canceled)

7. A manual pump assembly comprising:
a push member distributor;
a cap to engage a container;
an upper valve;
a lower part integrally formed by a method selected from blow molding and corrugation wherein said integral lower part has an annular support ring,
a lower valve position and a dip tube.

8. The manual pump assembly of claim 7 wherein the lower valve position comprises a check valve seat and a retaining detent.

9. The manual pump assembly of claim 7 wherein the lower valve position comprises a hinge connected to the annular support ring and a reed flap valve.

10. The manual pump assembly of claim 7 wherein the integral lower part further comprises a shot cavity.

11. The manual pump assembly of claim 10 wherein the shot cavity has corrugated walls that function as a return spring.

12. A manual pump assembly comprising:
a push member distributor;
an upper part integrally formed by a method selected from blow molding and corrugation wherein said integral upper part has a cap to engage a container, an upper valve position, and a shot cavity with corrugated walls functioning as a return spring;
an annular support ring;
a lower valve; and
a dip tube.

13. The manual pump assembly of claim 12 wherein the upper valve position comprises a check valve seat and the assembly further includes an upper check ball.

14. The manual pump assembly of claim 12 wherein the upper valve position comprises a reed valve flap and reed valve hinge.

15. The manual pump assembly of claim 12 wherein the integral upper part further comprises an annular threaded section to engage the push member distributor.

16. The manual pump assembly of claim 15 wherein the integral upper part further comprises a tamper evident stiffener.

17. The manual pump assembly of claim 16 wherein the push member distributor has an integral tamper evident fin that is tacked to the tamper evident stiffener to create a tamper evident seal.

18. The manual pump assembly of claim 15 wherein the integral upper part further comprises a stiffening fin that obstructs the annular threaded section such that the push member distributor rotates freely a quarter turn until obstructed by the fin.

19. The manual pump assembly of claim 11 wherein the cap to engage a container further comprises a protective cover for the shot cavity of the integral lower part.

20. The manual pump assembly of claim 7 wherein the cap to engage a container is integrally formed by a method selected from blow molding and corrugation together with a shot cavity having corrugated walls functioning as a return spring.

21. The manual pump assembly of claim 20 wherein the shot cavity has an upper end with a short tube with an annular thread.

22. The manual pump assembly of claim 20 wherein a stiffener is adjacent to the short tube.

23. The manual pump assembly of claim 12 wherein the annular support ring and dip tube are formed as a lower integral piece by a method selected from blow molding and corrugation.

24. The manual pump assembly of claim 23 wherein the lower integral piece further comprises a check valve seat and a detent.

25. The manual pump assembly of claim 23 wherein the lower integral piece further comprises a reed valve hinge and a reed flap valve.
